(19) United States
(12) Patent Application Publication
(10) Pub. No.: US 2025/0068614 A1
(43) Pub. Date: Feb. 27, 2025

(54) Data Processing System

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Chuo-Jui Wu, Taipei (TW); Jing-Lun Huang, Taipei (TW)

(73) Assignees: Inventec (Pudong) Technology Corp., Shanghai (CN); Inventec Corporation, Taipei (TW)

(21) Appl. No.: 18/389,678

(22) Filed: Dec. 19, 2023

(30) Foreign Application Priority Data
Aug. 25, 2023 (CN) 202311086749.8

(51) Int. Cl. G06F 16/22; G06F 16/23

(52) U.S. Cl. CPC G06F 16/2282; G06F 16/221; G06F 16/2379

(57) ABSTRACT

A data processing system is for uploading an upload data, wherein the upload data comprises a data content and a table name. The data processing system comprises a relational database; a NoSQL database; a data processing unit, coupled to the relational database and the NoSQL database, configured to execute a program code; and a storage unit, coupled to the data processing unit, configured to store the program code to instruct the data processing unit to execute a data processing method. The data processing method comprises determining a structure type of the upload data according to the data content; determining a first table of a first database according to the structure type, the data content and the table name of the upload data; and storing the upload data in the first table of the first database; wherein the first database is the relational database or the NoSQL database.

### BACKGROUND OF THE INVENTION

### 1. Field of the Invention

The present invention relates to a data processing system, and more particularly, to a data processing system capable of automatically performing database selection, data structure adjustment, and data migration based on data content.

### 2. Description of the Prior Art

With the digitization of information and the widespread use of the internet, there is a growing demand for accessing databases through application programming interfaces (API) across various fields. In order to meet the diverse needs of data applications, different types of databases have emerged. Nowadays, mainstream databases may be broadly categorized into two types: relational databases and non-relational databases (also known as NoSQL). The relational databases, such as Oracle, MySQL, and SQL Server, usually store data through multiple tables with predefined and strict structural relationships between the data and the tables. On the other hand, the NoSQL databases, such as MangoDB and Redis, are different from the traditional relational databases, which do not require a fixed table format for storing data and allow for arbitrary definition of data models, thus having greater flexibility and scalability. The use of API to access a database enables users to process data according to the definition of the API without requiring specialized knowledge of database technologies. This is particularly useful when dealing with various types of databases and diverse database technologies.

However, in general, before uploading data, users need to confirm their requirements with database technicians. The database technicians then select a database that meets the requirements, plan the relational structure of the data, and create corresponding tables based on the actual needs of the users. In addition, the database technicians must provide a customized API for accessing the data. Once the database and tables are set up and a certain amount of data is stored, any subsequent changes to the structure of the database or tables require database technicians to perform database migration or data structure adjustments. As the amount of information increases, this can become a considerable burden for the database technicians and result in high database migration costs. This problem is especially severe when using the relational databases. However, changing data content in response to changes in demand has always been an unavoidable issue in this field. Therefore, there is an urgent need to establish an automatic identification method that may automatically adjust the database and tables according to the data content uploaded by the user, so as to save manpower and reduce cost.

### SUMMARY OF THE INVENTION

Therefore, the present invention is to provide a data processing system capable of automatically differentiating the data content so as to improve the shortcomings of the prior art.

An embodiment of the present invention discloses a data processing system for uploading an upload data, and the upload data comprises a data content and a table name. The data processing system comprises a relational database, a NoSQL database, a data processing unit and a storage unit. The data processing unit is coupled to the relational database and the NoSQL database, and is configured to execute a program code. The storage unit is coupled to the data processing unit and configured to store the program code to instruct the data processing unit to execute a data processing method. The data processing method comprises determining a structure type of the upload data according to the data content; determining a first table of a first database according to the structure type, the data content and the table name of the upload data; and storing the upload data in the first table of the first database. The first database is the relational database or the NoSQL database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a user accessing a database through an API.

FIG. 2 is a schematic diagram of a data processing system according to an embodiment of the present invention.

FIG. 3 is a schematic diagram of a data processing process according to an embodiment of the present invention.

FIG. 4 is a schematic diagram of a structure type determination process according to an embodiment of the present invention.

FIG. 5 is a schematic diagram of a process according to an embodiment of the present invention.

FIG. 6 is a schematic diagram of a process according to an embodiment of the present invention.

FIG. 7 is a schematic diagram of a database migration process according to an embodiment of the present invention.

FIG. 8 is a schematic diagram of a data-table migration process according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”.

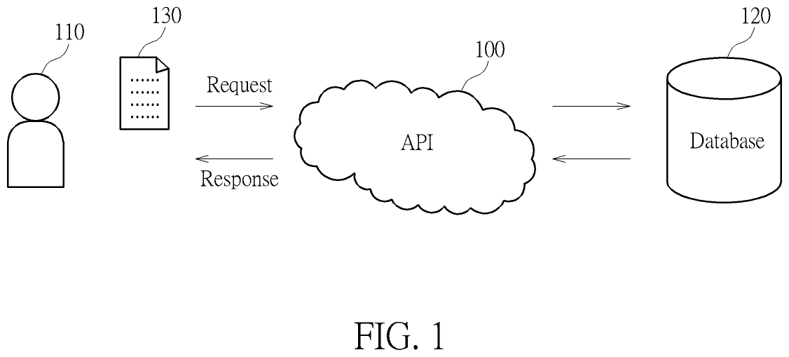

Please refer to FIG. 1, which is a schematic diagram of a user accessing a database through an API. As shown in FIG. 1, a user 110 sends a request for accessing a database 120 through an API 100 and gets a response from the database 120. During this process, the user 110 only needs to carry data 130 that needs to be stored in the database 120 in the request according to the specification defined by the API 100, and does not need to know the type of the database 120, and does not need to have any specialized knowledge related to the database 120. In general, the API 100 and the database 120 need to be planned in detail by the database technicians according to the requirements of users and implemented as a form easy to be accessed; however, once the system is put into use, the system is difficult to be changed. The data 130 may be a structured table, various types of multimedia data, or a collection of data with any data structure, and the structure and content of the data 130 may need to be updated at any time in response to changes in actual needs. In this situation, the database technicians need to fully consider the existing data structure stored in the database 120 and the requirements of the new data 130, and modify the table structure, inter-table association, the definitions of the API 100, etc. accordingly. Moreover, under specific requirements, the database technicians need to further consider data migration between different types of databases, and such updating process would consume considerable manpower and resources.

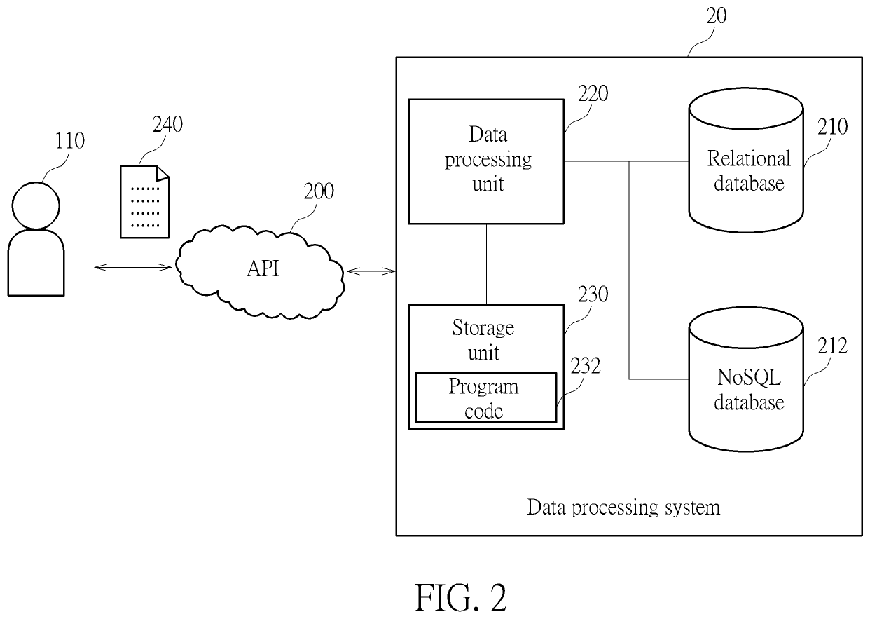

In view of the above problems, please refer to FIG. 2, which is a schematic diagram of a data processing system 20 according to an embodiment of the present invention. As shown in FIG. 2, the data processing system 20 comprises a relational database 210, a NoSQL database 212, a data processing unit 220 and a storage unit 230. The relational database 210 may be any relational database, such as Oracle, MySQL, SQL Server, and is not limited thereto. The NoSQL database 212 may be any NoSQL database, such as MangoDB, Redis, and is not limited thereto. The data processing unit 220 may be a general-purpose processor, a microprocessor, an application specific integrated circuit (ASIC) or a combination thereof. The storage unit 230 may be any types of data storage device for storing a program code 232, and the program code 232 is read and executed by the data processing unit 220. For example, the storage unit 230 may be a read-only memory (ROM), a flash memory, a random-access memory (RAM), a hard disk, an optical data storage device, a non-volatile storage unit, etc., and is not limited thereto.

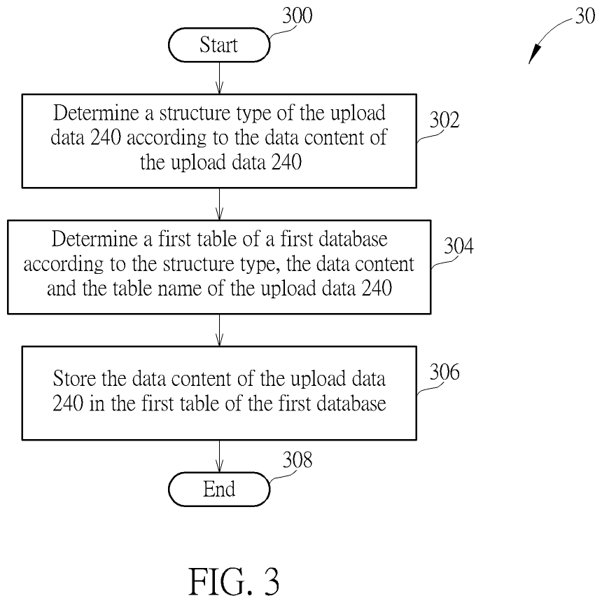

As shown in FIG. 2, the data processing 20 provides an API 200 for the user 110 to access an upload data 240, where the upload data 240 should at least comprise a table name and a data content thereof. The data processing system 20 executes a data processing method according to the upload data 240 sent by the user 110, and thereby determines the database and table suitable for storing the upload data 240, so as to achieve the purpose of automatic data storing. As shown in FIG. 3, the data processing method of the embodiment of the present invention may be summarized into a data processing process 30 and compiled to the program code 232. The data processing process 30 comprises the following steps:

Step 300: Start.

Step 302: Determine a structure type of the upload data 240 according to the data content of the upload data 240.

Step 304: Determine a first table of a first database according to the structure type, the data content and the table name of the upload data 240.

Step 306: Store the data content of the upload data 240 in the first table of the first database.

### Step 308: End.

According to the data processing process 30, in Step 302, the data processing system 20 first determines the structure type of the upload data 240 according to the data content of the upload data 240. Next, in Step 304, the data processing system 20 searches the relational database 210 and the NoSQL database 212 for the table name of the upload data 240 so as to determine whether relevant data has been stored in the data processing system 20 and accordingly determine the first database and the first table for finally storing the upload data 240. Finally, in Step 306, the data processing system 20 stores the data content of the upload data 240 in the first table of the first database determined in Step 304.

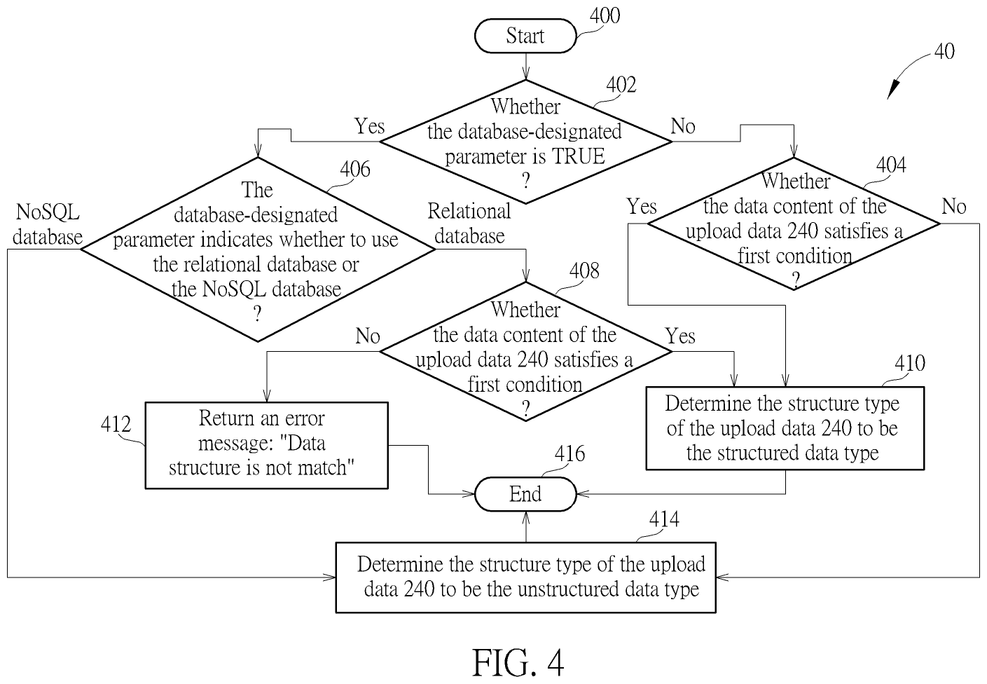

Specifically, in Step 302, the data processing system 20 determines the structure type of the upload data 240 according to the data content of the upload data 240. The structure type of the upload data 240 may be categorized into two types: structured data type and unstructured data type. Data of structured data type are suitable to be stored in the relational database 210, while data of unstructured data type are suitable to be stored in the NoSQL database 212. The embodiment of the present invention performs a further distinguish to determine where the upload data 240 should be finally stored on the basis of the structure type. In an embodiment, while receiving the upload data 240, the data processing system 20 may further receive a database-designated parameter specified by the user 110. The database-designated parameter may specify that the upload data 240 is to be stored in the relational database 210 or the NoSQL database 212. Please refer to FIG. 4, which is a structure type determination process 40 for structure type determination in Step 302. The structure type determination process 40 comprises the following steps:

Step 400: Start.

Step 402: Determine whether the database-designated parameter is TRUE? If yes, proceed to Step 406; otherwise, proceed to Step 404.

Step 404: Determine whether the data content of the upload data 240 satisfies a first condition? If yes, proceed to Step 410; otherwise, proceed to Step 414.

Step 406: Determine whether the database-designated parameter indicates to use the relational database or the NoSQL database? If the database-designated parameter indicates to use the relational database, proceed to Step 408; if the database-designated parameter indicates to use the NoSQL database, proceed to Step 414.

Step 408: Determine whether the data content of the upload data 240 satisfies a first condition? If yes, proceed to Step 410; otherwise, proceed to Step 412.

Step 410: Determine the structure type of the upload data 240 to be the structured data type.

Step 412: Return an error message: “Data structure is not match”.

Step 414: Determine the structure type of the upload data 240 to be the unstructured data type.

Step 416: End.

According to the structure type determination process 40, the data processing system 20 may determine the data structure of the upload data 240 stored in the data processing system 20 according to the data content of the upload data 240 and the database-designated parameter. The data processing system 20 first determines if the user 110 assigns the database-designated parameter or not (Step 402). If the user 110 does not assign the database-designated parameter, the data processing system 20 may automatically determine the structure type of the upload data 240 according to whether the data content of the upload data 240 satisfies a first condition (Step 404). When the first condition is satisfied, the data processing system 20 determines the structure type of the upload data 240 to be the structured data type (Step 410); when the first condition is not satisfied, the data processing system 20 determines the structure type of the upload data 240 to be the unstructured data type (Step 414). On the other hand, if the user 110 assigns the database-designated parameter (i.e., the value of the database-designated parameter is TRUE), the structure type of the upload data 240 needs to be further determined according to the database-designated parameter and the data content of the upload data 240 (Step 406). If the database-designated parameter indicates to use the relational database, the data processing 20 needs to further determine whether the data content of the upload data 240 satisfies the first condition (Step 408). When the data content of the upload data 240 satisfies the first condition, the data processing system 20 determines the structure type of the upload data 240 to be the structured data type (Step 410); when the data content of the upload data 240 does not satisfy the first condition, the data processing system 20 needs to return an error message to the user 110 and inform that the designated database type does not match the data structure (Step 412). If the database-designated parameter indicates to use the NoSQL database, the data processing system 20 may directly determine the structure type of the upload data 240 to be the unstructured data type (Step 414).

In the structure type determination process 40, the data processing system 20 determines the data format and structure type of the upload data 240 according to whether the data content of the upload data 240 satisfies the first condition. In an embodiment, the first condition may comprise:

a. The structure of the data content of the upload data 240 should be composed of column names and rows representing data value groups.

b. All data types of the data corresponding to the same column should be the same.

c. The data type of each column is one of floating point (including integers) (Float), date and time (Datetime), and strings (String).

When the above conditions are satisfied, the data processing system 20 may determine the data content of the upload data 240 to be a structured data type, or otherwise, to be the unstructured data type. In comparison with the unstructured data type, the structured data type has strict format restrictions and can be stored in relational database 210 or NoSQL database 212. Compared with the structured data type, the unstructured data type has a looser structure and can only be stored in the NoSQL database 212. When the user 110 does not assign the database-designated parameter, the data processing system 20 may directly determine the structure type of the upload data 240 according to the first condition. When the user 110 has assigned the database-designated parameter, the data processing system 20 has to consider the specified database type and whether the data content of the upload data 240 satisfies the first condition at the same time. If the data content of the upload data 240 fails to satisfy the first condition, the upload data 240 is not able to be stored in the relational database 210 with a relatively strict data structure. Therefore, if the user 110 specifies to use the relational database 210 under this condition, the data processing system 20 needs to return an error message and end the process.

Regarding the method of determining the data type in the first condition, some existing software or kits may be used, and are not limited thereto. For example, if Python is applied to check the data types, “dateutil.parser.parse” may be used to check Datatime, function “float( )” may be used to check floating point (Float), and function “isinstance(input, str)” may be used to check String. If the R language is applied to check the data types, “as. Date” may be used to check Datatime, function “float.TryParse(input, out valid_float)” may be used to check Float, and “is.character( )” may be used to check String. Those skilled in the art should use appropriate tools to check data types according to actual needs, and are not limited thereto.

According to the data processing process 30, in Step 304, the data processing system 20 determines the first table and the first database for storing the upload data 240 according to the structure type, the data content and the table name of the upload data 240. In this step, the data processing system 20 first searches the relational database 210 and the NoSQL database 212 according to the table name of the upload data 240 so as to determine whether relevant data has been stored in the data processing system 20 and accordingly determine the first database and the first table for finally storing the upload data 240

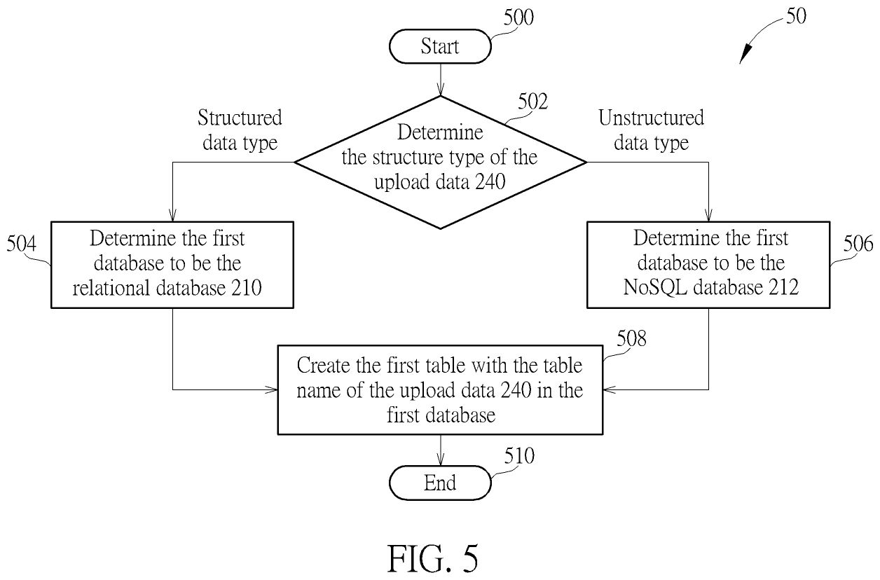

Please refer to FIG. 5, which shows a processing process 50 where when the data processing system 20 does not find a table matching the table name of the upload data 240 in the relational database 210 and the NoSQL database 212, the first database and the first table for actually storing the upload data 240 are determined according to the structure type of the upload data 240. In this situation, the data processing system 20 does not store any data related to the upload data 240, so the first database and the first table may be automatically determined according to the structure type of the upload data 240 determined in step 302 of the structure type determination process 40. The processing process 50 comprises the following steps:

Step 500: Start.

Step 502: Determine the structure type of the upload data 240. If the structure type of the upload data 240 is the structured data type, proceed to Step 504; if the structure type of the upload data 240 is the unstructured data type, proceed to Step 506.

Step 504: Determine the first database to be the relational database 210.

Step 506: Determine the first database to be the NoSQL database 212.

Step 508: Create the first table with the table name of the upload data 240 in the first database.

Step 510: End.

According to the processing process 50, the data processing system 20 needs to determine the first database according to the structure type of the upload data 240 determined in Step 302 (Step 502). When the structure type of the upload data 240 is the structured data type, the data processing system 20 determines the first database for storing the upload data 240 to be the relational database 210 (Step 504). When the structure type of the upload data 240 is the unstructured data type, the data processing system 20 determines the first database for storing the upload data 240 to be the NoSQL database 212 (Step 506). Finally, the data processing system 20 should create the first table according to the table name of the upload data 240 in the first database determined in Step 504 and Step 506, so as to store the data content of the upload data 240 (Step 508).

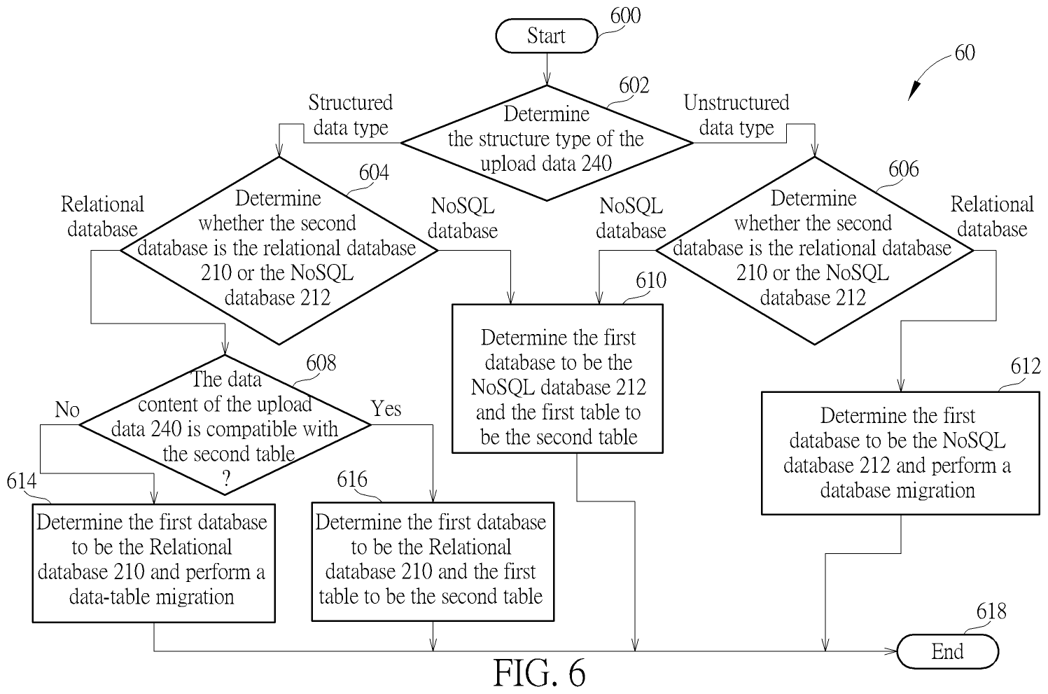

Please refer to FIG. 6, which shows a processing process 60 where the first database and the first table for actually storing the upload data 240 are determined when the data processing system 20 finds a table matching the table name of the upload data 240 in the relational database 210 or in the NoSQL database 212. Assume that the data processing system 20 finds a second table matching the table name of the upload data 240 in a second database. In this case, the data processing system 20 needs to consider the compatibility among the second database, the second table and the upload data 240 to determine the first database and the first table. The processing process 60 comprises the following steps:

Step 600: Start.

Step 602: Determine the structure type of the upload data 240. If the structure type of the upload data 240 is the structured data type, proceed to Step 604; if the structure type of the upload data 240 is the unstructured data type, proceed to Step 606.

Step 604: Determine whether the second database is the relational database 210 or the NoSQL database 212. If the second database is the relational database 210, proceed to Step 608; if the second database is the NoSQL database 212, proceed to Step 610.

Step 606: Determine whether the second database is the relational database 210 or the NoSQL database 212. If the second database is the relational database 210, proceed to Step 612; if the second database is the NoSQL database 212, proceed to Step 610.

Step 608: Determine whether the data content of the upload data 240 is compatible with the second table? If yes, proceed to Step 616; otherwise, proceed to Step 614.

Step 610: Determine the first database to be the NoSQL database 212 and the first table to be the second table.

Step 612: Determine the first database to be the NoSQL database 212 and perform a database migration process.

Step 614: Determine the first database to be the relational database 210 and perform a data-table migration process.

Step 616: Determine the first database to be the relational database 210 and the first table to be the second table.

### Step 618: End.

According to the processing process 60, the data processing system 20 needs to determine the first database and the first table according to the structure type of the upload data 240 and the type of the second database (Steps 602-606). When the second database is the NoSQL database 212, the upload data 240 should be stored in the NoSQL database 212 no matter whether the structure type of the upload data 240 is the structured data type or the unstructured data type. In this situation, the data processing system 20 determines the first database to be the NoSQL database 212 and the first table to be the second table (Step 610). In other words, the upload data 240 may be stored in the existing second table of the second database directly.

Furthermore, when the second database is the relational database 210, the data processing system 20 needs to check if the upload data 240 is suitable to be stored in the relational database 210 together with the data content of the second table according to the structure type of the upload data 240. For example, when the second database is the relational database 210 and the structure type of the upload data 240 is the unstructured data type, the relational database 210 is not possible to store the unstructured data of the upload data 240. Accordingly, the data processing system 20 needs to transfer the data of the second table from the relational database 210 to the NoSQL database 212 first, and then perform the data storing for the upload data 240. Therefore, the data processing system 20 determines the first database to be the relational database 212 and performs a database migration process (Step 612).

On the other hand, when the second database is the relational database 210 and the structure type of the upload data 240 is the structured data type, the upload data 240 is possible to be stored in the relational database 210. Due to the strict definition of the database schema for the storage in the relational database, the data processing system 20 needs to check whether the data content of the second table and the upload data 240 are compatible before directly storing the upload data 240 to the second table (Step 608). If all columns and data types of the data content of the upload data 240 are compatible or consistent with the second table, the data processing system 20 may directly store the data content of the upload data 240 in the second table. Therefore, the data processing system 20 may determine the first database to be the relational database 210 and the first table to be the second table (Step 616). If compared with the second table, the data content of the upload data 240 includes all the columns of the second table and further includes new columns, the upload data 240 is not possible to be directly stored in the second table. In this situation, the data processing system 20 needs to expand the columns of the table first, and then store the upload data 240. Therefore, the data processing system 20 may determine the first database to be the relational database 210 and perform a data-table migration process (Step 614).

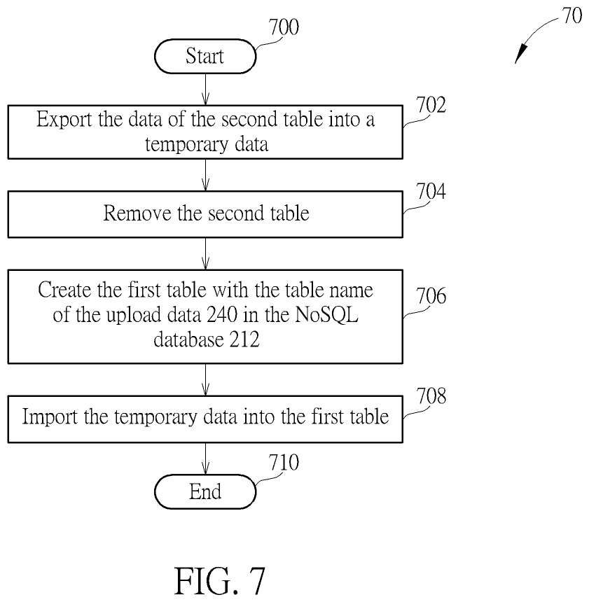

Please refer to FIG. 7, which is a schematic diagram of a database migration process 70 in Step 612 according to an embodiment of the present invention. The database migration process 70 comprises the following steps:

Step 700: Start.

Step 702: Export the data of the second table into a temporary data.

Step 704: Remove the second table.

Step 706: Create the first table with the table name of the upload data 240 in the NoSQL database 212.

Step 708: Import the temporary data into the first table.

Step 710: End.

According to the database migration process 70, after exporting the data content of the second table and saving as a temporary data (Step 702), the data processing system 20 may remove the second table (Step 704). Next, the data processing system 20 may create the first table with the table name of the upload data 240 in the NoSQL database 212 (Step 706). Finally, the data processing system 20 may import the temporary data into the new created first table (Step 708). Accordingly, the cross-database data migration of the second table may be completed, and the first table compatible with the upload data 240 may be created in the NoSQL database 212.

In an embodiment, while receiving the upload data 240, the data processing system 20 may further receive a database migration parameter specified by the user 110 at the same time. When the value of the database migration parameter is TRUE, no matter whether the upload data 240 is the unstructured data type, the data processing system 20 may execute the database migration process 70 to transfer the data of the second table stored in the relational database 210 to the newly created first table in the NoSQL database 212. In the case that the user 110 does not assign the database migration parameter, the data processing system 20 may determine the data processing way according to the processing process 60.

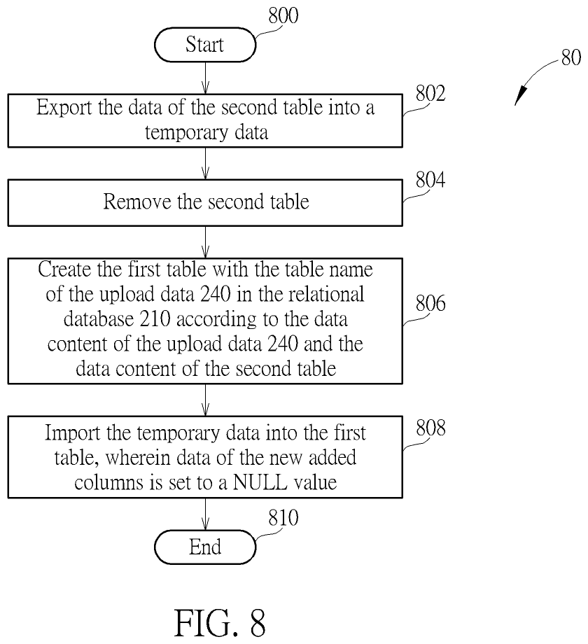

Please refer to FIG. 8, which is a schematic diagram of a data-table migration process 80 in Step 614 according to an embodiment of the present invention. The data-table migration process 80 comprises the following steps:

Step 800: Start.

Step 802: Export the data of the second table into a temporary data.

Step 804: Remove the second table.

Step 806: Create the first table with the table name of the upload data 240 in the relational database 210 according to the data content of the upload data 240 and the data content of the second table.

Step 808: Import the temporary data into the first table, wherein data of the new added columns is set to a NULL value.

Step 810: End.

According to the data-table migration process 80, after exporting the data content of the second table and saving as a temporary data (Step 802), the data processing system 20 may remove the second table (Step 804). Next, the data processing system 20 may create the first table with the table name of the upload data 240 in the NoSQL database 212 according to the data structure of the upload data 240 and the temporary data (Step 806). Finally, the data processing system 20 may import the temporary data into the new created first table (Step 808). Accordingly, the cross-table data migration of the second table may be completed, and the first table compatible with the upload data 240 may be created.

Accordingly, according to the processing processes 50, 60, the database migration process 70 and the data-table migration process 80 in Step 304, the data processing system 20 may automatically identify the structure type of the upload data 240 and determine the appropriate database and table according to the existing data in the data processing system 20. Therefore, the burden of manpower and resources caused by the change of data structure is reduced.

Finally, in Step 306, the data processing system 20 may store the upload data 240 according to the first database and the first table determined in Step 304.

In summary, the present invention provides the data processing system and the data processing method, so that the users do not need to repeatedly confirm the requirements with the database technicians before uploading data. When there is any change in the upload data, there is no need to spend huge labor costs and time to perform the database structure adjustment, data migration and API revision. Therefore, the present invention improves the shortcomings of the prior art and meets the requirements of practical applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system for uploading an upload data, wherein the upload data comprises a data content and a table name, the data processing system comprising:
a relational database;
a NoSQL database;
a data processing unit, coupled to the relational database and the NoSQL database, configured to execute a program code; and
a storage unit, coupled to the data processing unit, configured to store the program code to instruct the data processing unit to execute a data processing method, wherein the data processing method comprises:
determining a structure type of the upload data according to the data content;
determining a first table of a first database according to the structure type, the data content and the table name of the upload data; and
storing the upload data in the first table of the first database;
wherein the first database is the relational database or the NoSQL database.

2. The data processing system of claim 1, wherein the structure type is divided into a structured data type and an unstructured data type.

3. The data processing system of claim 2, wherein the step of determining the structure type of the upload data according to the data content comprises when the data content of the upload data satisfies a first condition, determining the structure type of the upload data as the structured data type; otherwise, determining the structure type of the upload data as the unstructured data type, wherein the first condition comprises:
the data content comprising at least one column;
data types of data corresponding to each column of the at least one column being consistent; and
data types of the data of the each column of the at least one column being one of floating point, integer, datetime and string.

4. The data processing system of claim 3, further receiving a database-designated parameter specified by a user and determining the structure type according to the database-designated parameter, wherein the step of determining the structure type of the upload data according to the data content further comprises:
determining the structure type of the upload data to be the structured data type in response to the database-designated parameter indicating using the relational database and the data content of the upload data satisfying the first condition;
returning an error message to the user in response to the database-designated parameter indicating using the relational database and the data content of the upload data not satisfying the first condition; and
determining the structure type of the upload data to be the unstructured data type in response to the database-designated parameter indicating using the NoSQL database.

5. The data processing system of claim 2, wherein the step of determining the first table of the first database according to the structure type, the data content and the table name of the upload data comprises:
determining whether a second table with the table name is stored in the data processing system, wherein the second table is stored in a second database of the data processing system;
in response to the second table not existing, determining the first database according to the structure type of the upload data and creating the first table with the table name in the first database; and
in response to the second table existing, determining the first database and the first table according to the upload data and the second table.

6. The data processing system of claim 5, wherein the step of in response to the second table not existing, determining the first database according to the structure type of the upload data and creating the first table with the table name in the first database comprises:
in response to the structure type of the upload data being the structured data type, determining the first database to be the relational database; and
in response to the structure type of the upload data being the unstructured data type, determining the first database to be the NoSQL database.

7. The data processing system of claim 5, wherein the step of in response to the second table existing, determining the first database and the first table according to the upload data and the second table comprises:
in response to the structure type of the upload data being the structured data type and the second database being the relational database, determining the first database and the first table according to the data content of the upload data and the second table;
in response to the structure type of the upload data being the structured data type and the second database being the NoSQL database, determining the first database to be the NoSQL database and the first table to be the second table;
in response to the structure type of the upload data being the unstructured data type and the second database being the relational database, determining the first database to be the NoSQL database and performing a database migration; and
in response to the structure type of the upload data being the unstructured data type and the second database being the NoSQL database, determining the first data base to be the NoSQL database and the first table to be the second table.

8. The data processing system of claim 7, wherein the step of in response to the structure type of the upload data being the structured data type and the second database being the relational database, determining the first database and the first table according to the data content of the upload data and the second table comprises:
in response to all columns and data types of the data content of the upload data matching the second table, determining the first database to be the relational database and determining the first table to be the second table; and
in response to all columns of the second table matching a subset of the all columns of the data content of the upload data and the data content of the upload data having new added columns, determining the first database to be the relational database and performing a data-table migration.

9. The data processing system of claim 8, wherein the step of the data-table migration comprises:
exporting data of the second table into a temporary data;
removing the second table;
creating the first table with the table name in the relational database according to the data content of the upload data and a data content of the second table; and
importing the temporary data into the first table, wherein data of the new added columns is set to a NULL value.

10. The data processing system of claim 7, wherein in response to the structure type of the upload data being the unstructured data type and the second database being the relational database, determining the first database to be the NoSQL database and performing a database migration comprises:
exporting data of the second table into a temporary data;
removing the second table;
creating the first table with the table name in the NoSQL database; and
importing the temporary data into the first table.
